(19) United States
(12) Patent Application Publication
(10) Pub. No.: US 2013/0160297 A1
(43) Pub. Date: Jun. 27, 2013

(54) Razor Assembly

(71) Applicant: Eveready Battery Company Inc., St. Louis, MO (US)

(72) Inventors: John Coleman, Philadelphia, PA (US); Siddharth Gulati, Raritan, NJ (US); David Noble, Wallingford, CT (US); Andrew Pennella, Milford, CT (US); David Schiff, Highland Park, NJ (US)

(73) Assignee: Eveready Battery Company Inc., St. Louis, MO (US)

(21) Appl. No.: 13/716,436

(22) Filed: Dec. 17, 2012

Related U.S. Application Data
(60) Provisional application No. 61/578,333, filed on Dec. 21, 2011.

(51) Int. Cl. B26B 21/44

(52) U.S. Cl. CPC B26B 21/446
USPC 30/41

(57) ABSTRACT

A safety razor adapted to deliver a non-solid shaving aid material during normal use includes a handle, a razor cartridge and a reservoir for the shaving aid material in fluid communication with an applicator of the razor cartridge. When the non-solid shaving aid material includes liquid oil, the applicator has an outer layer of a hydrophobic non-woven material and an inner body of an oleophilic fibre pad. The reservoir can include a body of an oleophobic and hydrophilic fibre material

### CROSS REFERENCE TO RELATED APPLICATIONS

This application claims the benefit of U.S. provisional Patent Application Ser. No. 61/578,333, filed Dec. 21, 2011, the content of which is incorporated herein for reference in its entirety.

### BACKGROUND

1. Field of the Present Disclosure

The present disclosure is generally directed to shaving implements, specifically safety razors, wherein the safety razor stores and dispenses non-solid shaving aid material(s) during use.

2. Background

Many modern safety razors include a disposable razor cartridge adapted to be selectively connected to a reusable handle by cartridge support structure therebetween. The cartridge includes a housing having a plurality of razor blades each having a sharpened cutting edge disposed therein. Other modern safety razors have a handle and a razor cartridge that are intended to be permanently coupled and disposed of as a single unit.

There have been many proposals to provide a safety razor having a razor cartridge in fluid communication with a reservoir adapted to store a non-solid shaving aid material However, such razors have not been successfully commercialized or at least not manufactured on a scale that is significant in a mass market such as that of safety razors.

Several difficulties arise when trying to provide a safety razor that can store and dispense non-solid shaving aid material in a manner that meets consumer expectations. A safety razor is typically normally used in a wet environment. Reverse flow of water from the shaving environment into the reservoir as the shaving aid material is used can be undesirable. Any such environmental water infiltration can dilute, emulsify or otherwise undesirably react with the remaining shaving aid material in the reservoir. Furthermore such environmental water infiltration can import micro-organisms into the reservoir resulting in undesirable bacterial, fungal or other growths in the reservoir.

### SUMMARY

The present disclosure has for its objective to eliminate, or at least substantially alleviate the limitations of the prior art safety razors. The present disclosure in one aspect is directed safety razor having a handle supporting a razor cartridge and a reservoir adapted to contain a portion of a non-solid shaving aid material. The razor cartridge includes an applicator adapted to deposit the non-solid shaving aid on a skin surface of a user during a normal shaving operation. In some aspects the top surface of the applicator is angled inward relative to a shave plane of the razor cartridge. The reservoir is in fluid communication with the applicator. For a non-solid shaving aid material comprising liquid oil the applicator preferably comprises an outer layer of a hydrophobic non-woven material and an inner body of an oleophilic fibre pad. In some aspects the reservoir includes a body of an oleophobic and hydrophilic fibre material

In use the oleophilic fibre pad of the applicator, in fluid communication with the reservoir will absorb the liquid oil from the reservoir and be substantially filled by the oil. The hydrophobic non-woven material outer layer provides a soft yet durable surface to resist abrasion of the applicator from sliding contact with the hirsute skin surface of a user over the useful life of the razor cartridge while transferring oil from the oleophilic fibre pad to the users skin surface. The hydrophobic nature of the outer layer resists the infiltration of environmental water to the oleophilic fibre pad. The oleophilic fibre pad, being substantially filled with oil resists the infiltration of any environmental water that passed through the outer layer to the oleophilic fibre pad to the reservoir. In some aspects of the present disclosure the reservoir includes a body of an oleophobic and hydrophilic fibre material. This body in the reservoir resists the absorption of the oil of the reservoir while its hydrophilic nature causes it to absorb and retain any environmental water that might infiltrate the reservoir. In this manner emulsification or dilution of the oil can be reduced. The oleophilic fibre pad can comprise spun polyester/polyamide. The body in the reservoir can be treated with a fungicide and/or bactericide.

These and other features and will be more fully understood with reference to the following detailed description when taken in conjunction with the accompanying drawings.

### BRIEF DESCRIPTION OF THE DRAWINGS

FIG. 1 is sectional view of an embodiment of the present disclosure.

FIG. 1A is an enlarged portion of FIG. 1.

### DETAILED DESCRIPTION

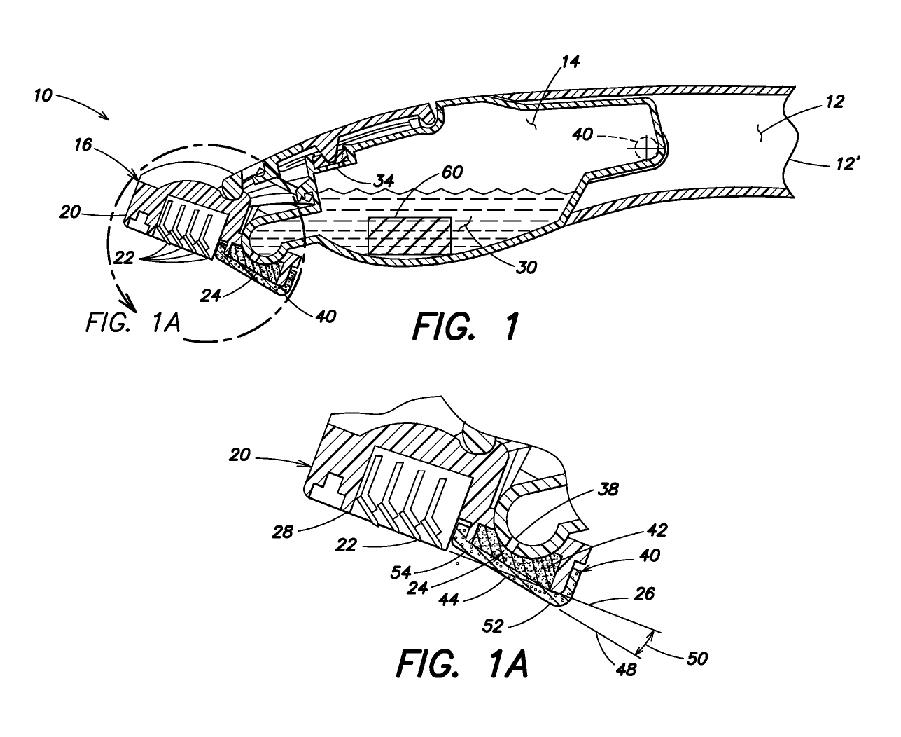

Referring now to the drawings, a portion of an exemplary safety razor 10 is depicted in a sectional view. The safety razor 10 includes a handle 12, a reservoir 14 and a razor cartridge 16 mounted e.g. pivotally mounted, on the handle 12. For convenience of depiction only a portion of the razor handle 12 is depicted in FIG. 1. One of skill in the art will understand that the handle can extend beyond hypothetical break line 12′ to provide a more convenient hand gripping portion that can be styled and/or provided with elastomeric gripping portions accordingly.

The razor cartridge 16 includes one or more razor blades 22 mounted in a housing 20. The razor cartridge defines a shave plane 26 extending through the cutting edge(s) of the razor blades 22 and optionally approximately tangentially to an adjacent skin engaging surface 28 of the housing, e.g. a cap or a guard. The razor cartridge also includes an applicator 24 provided to apply a non-solid shaving aid material, as will be described later in the present disclosure, to the skin surface of a user during a normal shaving operation.

The reservoir 14 can be fixedly mounted in the handle 12 or, preferably, as depicted in the figures, is slidable along the handle. In this regard the reservoir can include a guide pin 40 (shown in hidden detail as this extends externally to the reservoir and not seen in a sectional view). Guide pin 40 is disposed in, and slides along a slot (not shown) of the handle. In this manner the razor cartridge can be pivotal relative to the handle and in response thereto when the reservoir pivots relative to the razor cartridge. In use of the safety razor, reservoir 14 contains a portion of a non-solid shaving aid material 30, preferably comprising a liquid oil having a kinematic viscosity in the range about 20 cSt to about 40 cSt. The reservoir can be provided with a vent 34 to relieve any partial vacuum caused when non-solid shaving aid material is removed from the reservoir by operation of the safety razor. A suitable vent is disclosed in our concurrently filed patent application having Attorney Docket number SWS-1005 and Ser. No. 61/578,336, incorporated herein for reference in its entirety. The reservoir 14 is in fluid communication with the razor cartridge 16. Fluid communication can be via one or more ports 38 to permit the flow of shaving aid material to the applicator 24.

When the non-solid shaving aid material comprises liquid oil the applicator preferably comprises a hydrophobic material layer 40 preferably a non-woven material, over an oleophilic material 42 preferably a fibre pad. As a part of the hydrophobic material layer 40 is in contact with a user's skin during a normal shaving operation this material should preferably feel soft to the user but should also resist abrasion from rubbing contact with the user's skin over the useful life of the razor cartridge. A suitable material is a spun polyester/polyamide such as EVOLON®, particularly EVOLON® 170 provided by Freudenberg. The spun polyester/polyamide material can be treated, for example by a surface treatment to increase its hydrophobic nature. Suitable treatments are Acetic Acid or NUVA® 2110 provided by Clariant Textile Chemicals. NUVA® 2110 liquid is a Laundry Air Dry and Low Curing fluorocarbon for finishing and technical textile applications. A suitable oleophilic material 42 is melt-blown polypropylene fibre.

The outer surface 44 of the hydrophobic material layer is preferably angled inward relative to the cartridge. That is, a portion of the hydrophobic material layer 52 spaced away from the razor blades is further from the shave plane 26 than a portion of the hydrophobic material layer 54 spaced closer to the razor blades. For example, a plane 48 through all or part of the outer surface can define an angle 50 relative to shave plane 26 as shown in FIG. 1A. The outer surface 44 can also be curved or have another non-planar form.

As depicted in the Figures, the applicator can be in the guard region of the razor cartridge, ie. positioned to contact a user's skin in advance of the razor blades. The applicator can also be positioned after the razor blades in the cap region of the razor cartridge in the alternative or in addition to the guard region. The applicator can also be positioned between groups of blade(s) and the present disclosure should not be considered limited in regard to the location of the applicator.

In use of the safety razor, the oleophilic fibre pad 42 of the applicator 24, in fluid communication with the reservoir will absorb the liquid oil 30 from the reservoir and be substantially engorged by the oil. The hydrophobic material outer layer 40 provides a soft yet durable surface to resist abrasion of the applicator from sliding contact with the hirsute skin surface of a user over the useful life of the razor cartridge while transferring oil from the oleophilic fibre pad 42 to the user's skin surface. The hydrophobic nature of the outer layer 40 resists the infiltration of environmental water to the oleophilic fibre pad 42. The oleophilic fibre pad 42, being substantially engorged with oil resists the infiltration of any environmental water that might pass through the outer layer 40 to the oleophilic fibre pad 42 and to the reservoir 14. In some aspects of the present disclosure the reservoir includes a body 60 of an oleophobic and hydrophilic fibre material. This body in the reservoir resists the absorption of the oil of the reservoir while its hydrophilic nature causes it to absorb and retain any environmental water that might infiltrate the reservoir. In this manner emulsification or dilution of the oil can be reduced. A suitable material for the body 60 of the reservoir is EVOLON® 130 also provided by Freudenberg. The EVOLON® 130 material can include a surface treatment such as HYDROPERM® T or NUVA® N4118 also provided by Clariant Textile Chemicals to provide suitable oleophobic and hydrophilic characteristics. The body 60 can also be treated with a fungicide and/or bactericide.

While various embodiments have been described above, it should be understood that they have been presented by way of example only, and not limitation. For instance, modifications or changes as can be made within the scope of the attached claims and features disclosed in connection with any one embodiment can be used alone or in combination with each feature of the respective other embodiments. Thus, the breadth and scope of any embodiment should not be limited by any of the above described exemplary embodiments, but should be defined only in accordance with the following claims and their equivalents.

What is claimed is:

1. A safety razor, comprising:
a handle;
a reservoir adapted to contain a portion of a non-solid shaving aid, at least partially disposed in the handle; and
a razor cartridge defining a shave plane mounted to the handle comprising an applicator adapted to deposit the non-solid shaving aid on a skin surface of a user during a normal shaving operation, wherein reservoir is in fluid communication with the applicator, and
wherein the applicator comprises an outer layer of a hydrophobic material and an inner body of an oleophilic material.

2. The safety razor of claim 1, wherein the hydrophobic material is a non-woven material

3. The safety razor of claim 1, wherein the oleophilic material is a fibre pad.

4. The safety razor of claim 1, wherein the reservoir contains the portion of the non-solid shaving aid material and wherein the shaving aid material comprises liquid oil.

5. The safety razor of claim 4, wherein the liquid oil has a kinematic viscosity in the range about 20 cSt to about 40 cSt.

6. The safety razor of claim 1, wherein a top surface of the applicator is angled relative to the shave plane.

7. The safety razor of claim 6, wherein the angle is inward.

8. The safety razor of claim 1, wherein the reservoir includes a body of an oleophobic and hydrophilic fibre material

9. The safety razor of claim 3, wherein the fibre pad comprises spun polyester/polyamide.
